(19) United States
(12) Patent Application Publication
(10) Pub. No.: US 2007/0001358 A1
(43) Pub. Date: Jan. 4, 2007

(54) Tunable top mount

(75) Inventors: Neil Stewart Cummings, Ann Arbor, MI (US); Mickey L. Love, Londonderry, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/170,612

(22) Filed: Jun. 29, 2005

(51) Int. Cl. B60G 15/00

(52) U.S. Cl. 267/219

(57) ABSTRACT

A suspension top mount is provided with vibration isolating properties by using a rigid insert combined with a stiff elastomer and a soft elastomer to provide tunable combinations of stiffness and damping.

### FIELD OF THE INVENTION

The present invention relates to suspension systems in motor vehicles, and more particularly to a tunable top mount for a suspension system in a motor vehicle.

### BACKGROUND AND SUMMARY OF THE INVENTION

Automobile vehicle suspension systems have become highly sophisticated and have proven to be extremely effective in isolating the vehicle from the road vibrations.

The MacPherson strut-type suspension system is generally used on most subcompact and compact cars with front wheel drive. The MacPherson system features a long telescopic shock absorber strut 10 surrounded by a coil spring 12. The upper end of the strut is generally isolated by an upper mount 14 that contains a bearing which allows for the turning of the wheel, while the lower end of the strut is typically attached to the steering knuckle 16 of the lower control arm ball joint. The lower control arm can be attached to the underbody side apron of the vehicle, or to the lower side rails of the vehicle, and is also typically attached to the steering knuckle.

The present invention relates to an improved upper mount for the MacPherson strut system that allows for the top mount to have tunable combinations of stiffness and damping. The top mount of the present invention provides isolation properties while maintaining good ride and handling characteristics. The vibration isolation top mount of the present invention includes a metal insert adapted to be mounted to the suspension strut member. The metal insert has a base portion and a sidewall portion extending from the base portion. An elastomer is disposed on the sidewall portion of the metal insert and a microcellular urethane is disposed on the base portion of the metal insert. The microcellular urethane has less stiffness than the elastomer and allows the stiffness of the top mount to be specifically tuned to absorb vehicular vibrations.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a plan view of an exemplary MacPherson strut suspension system for a vehicle incorporating the tunable top mount according to the principles of the present invention;

FIG. 2 is a perspective view of the tunable top mount according to the principles of the present invention;

FIG. 3 is a cross-sectional view of the tunable top mount according to the principles of the present invention;

FIG. 4 is a top plan view of the tunable top mount according to the principles of the present invention; and

FIG. 5 is a cross-sectional view of an alternative embodiment of the tunable top mount according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

As is described above in the background and summary section, the top mount 14 according to the principles of the present invention is used in a MacPherson strut suspension assembly, but can also be utilized for mounting the top end of any vehicle strut.

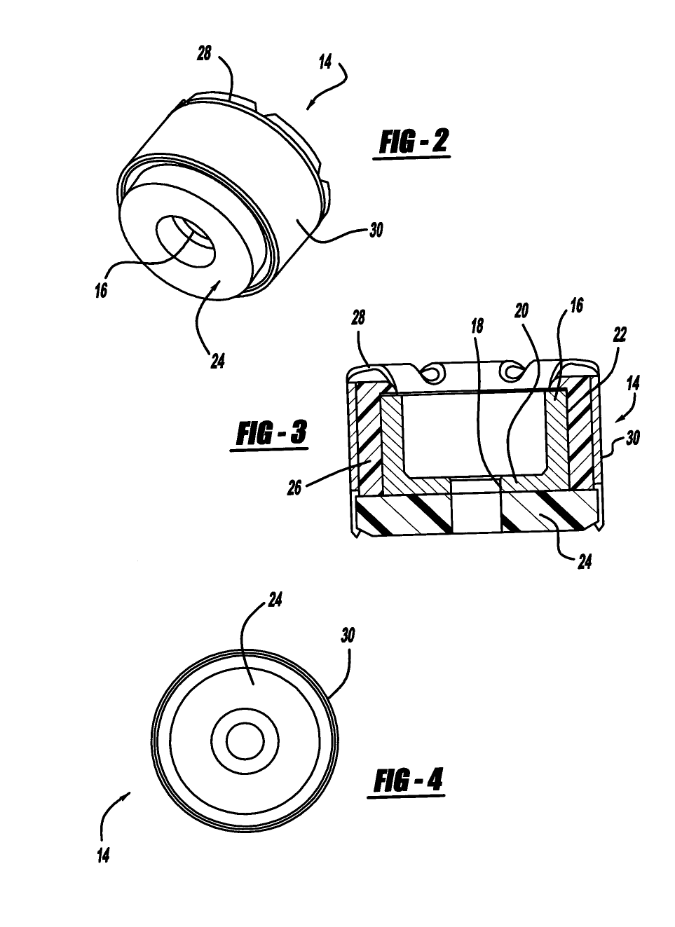

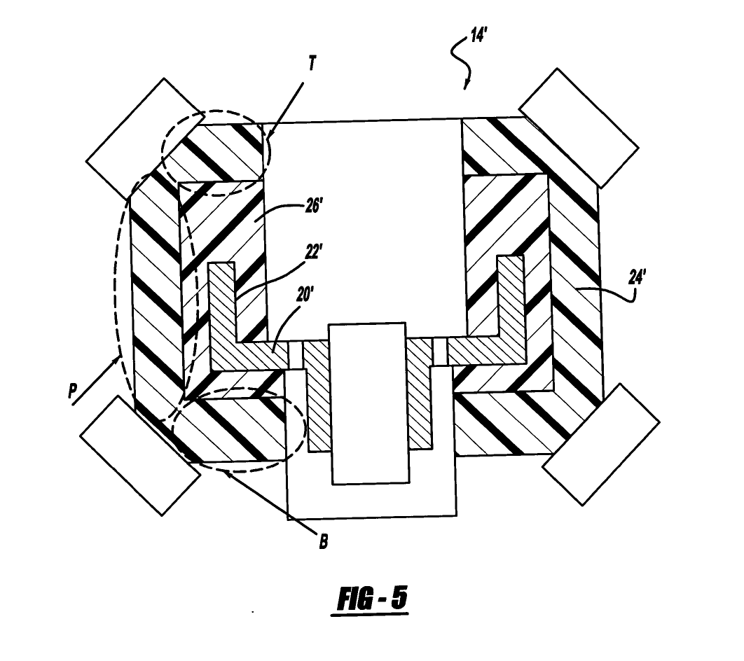

With reference to FIGS. 2-4, the tunable top mount 14 includes a rigid metal insert 16, having a generally cup-shaped configuration with an aperture 18 provided in the base 20 and a cylindrical side wall 22 extending from the base 20. A microcellular urethane (MCU) is disposed in covering relationship over the exterior surface of the base 20 of the insert 16. The MCU 24 is generally ring-shaped and provides a cushion between the metal insert 16 and an upper portion of the strut 10. An elastomer 26 is provided on the exterior surface of the side walls 22 of the insert 16. The stiff elastomer 26 is stiffer than the MCU 24 and is preferably made from a material such as solid urethane, although other materials such as general families of TPEs, blended elastomers such as SANTOPRENE thermoplastic vulcanizate, SANTOPRENE 8000 thermoplastic vulcanizate, VYRAM thermoplastic vulcanizate, GEOLAST thermoplastic vulcanizate, TREFSIN thermoplastic vulcanizate, VISTAFLEX thermoplastic elastomer, DYTRON thermoelastic elastomer, HYTREL and SARLINK can also be utilized.

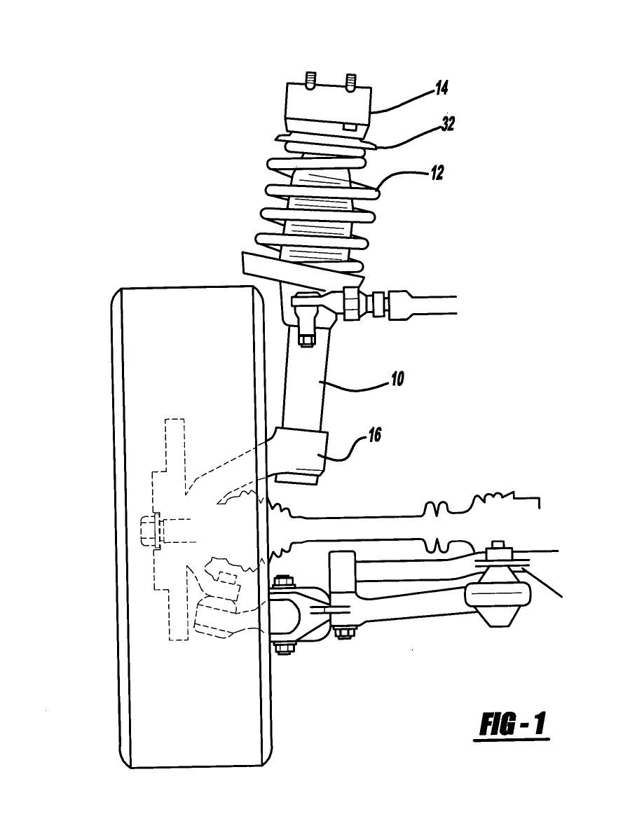

An upper mount plate 28 is provided for mounting the top mount 14 to the vehicle body or frame, as is known in the art. An outer casing or housing 30 surrounds the stiff elastomer 26 and MCU 24. The metal insert 16, when surrounded by the elastomer 26 is constrained in the housing 30. The housing 30 may be made of multiple elements that constrain and in most cases compress the elastomer 26 of the top mount element. The housing 30 can be manufactured independently and can then be bolted, welded or otherwise fastened to the vehicle frame or body. Alternatively, a portion of the housing can be manufactured as an integral part of the vehicle, then the balance of the housing assembly can be assembled or mounted to the vehicle. The aperture 18 in the insert 16 is provided for receiving the upper end of the strut 20 therein for mounting the insert 16 thereto. Top mount 14, according to the principles of the present invention, allows for tunable combinations of stiffness and damping. The stiffness and thickness of the MCU 24 and the outer layer of elastomer 26 provides the mount with isolation properties that maintain good ride and handling characteristics. A bottom plate 32 (shown in FIG. 1) is connected to the housing 30 and includes a central hole for receiving the strut therethrough. The MCU 24 is contained between the bottom plate 32 and the metal insert 16. The insert 16 provides a failsafe in case the elastomers are damaged, the insert is sized to prevent the insert from passing through the clearance holes in top of the housing 30 or the bottom plate 32.

As illustrated in FIG. 5, an alternative top mount arrangement is provided in which the insert 16′ is surrounded by the stiff elastomer 26′ both along the base 20′ and on the interior and exterior of the sidewalls 22′. In addition, the MCU 24′ is disposed overtop of the stiff elastomer 26′ along both the base and sidewalls thereof. Thus, the combination of softer MCU and stiffer elastomeric material can be selectively used to provide appropriate isolation properties. In particular, the base portion “B” of the top mount 14 provides a rebound stopper area while the perimeter portion “P” of the top mount provides a radial sheer area. The top portion “T” of the top mount 14 provides a jounce stopper area.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vibration isolator top mount, comprising:
a metal insert adapted to be mounted to a suspension member, said metal insert having a base portion and a sidewall portion extending from said base portion;
an elastomer disposed on said sidewall portion of said metal insert; and
a microcellular urethane disposed on said base portion of said metal insert.

2. The vibration isolator top mount of claim 1, wherein said microcellular urethane is disposed on an external surface of said elastomer.

3. The vibration isolator top mount of claim 1, wherein said elastomer is more stiff than said microcellular urethane.

4. The vibration isolator top mount of claim 2, wherein said elastomer is more stiff than said microcellular urethane.

5. The vibration isolator top mount of claim 1, wherein said elastomer is disposed on said base portion of said metal insert between said base portion and said microcellular urethane.

6. The vibration isolator top mount of claim 2, wherein said elastomer and said microcellular urethane cover an end of said sidewall portion opposite said base portion.

7. A vibration isolator top mount, comprising:
a metal insert adapted to be mounted to a suspension member, said metal insert having a base portion and a sidewall portion extending from said base portion;
a first material disposed on said sidewall portion of said metal insert, said first material having a first stiffness; and
a second material disposed on said base portion of said metal insert, said second material having a second stiffness, softer than said first stiffness.

8. The vibration isolator top mount according to claim 7, wherein said second material is disposed on an external surface of said first material.

9. The vibration isolator top mount according to claim 7, wherein said first material is disposed on said base portion of said metal insert between said base portion and said second material.

10. The vibration isolator top mount according to claim 7, wherein said first material is an elastomer.

11. The vibration isolator top mount according to claim 10, wherein said second material is a micro-cellular urethane.

12. The vibration isolator top mount according to claim 7, wherein said second material is disposed over an end of said sidewall portion opposite said base portion.

13. The vibration isolator top mount according to claim 7, further comprising an outer casing surrounding said metal insert.

14. The vibration isolator top mount according to claim 13, further comprising an upper mount plate connected to said outer casing.
